(19) United States
(12) Patent Application Publication
(10) Pub. No.: US 2015/0316441 A1
(43) Pub. Date: Nov. 5, 2015

(54) METHOD AND APPARATUS FOR TESTING QUALITY OF SEAL AND PACKAGE INTEGRITY

(71) Applicant: UNIVERSITY OF FLORIDA RESEARCH FOUNDATION, INC., GAINESVILLE, FL (US)

(72) Inventors: GHATU SUBHASH, GAINESVILLE, FL (US); SPYROS A. SVORONOS, GAINESVILLE, FL (US); AARON P. SIMON, TAMPA, FL (US); ALEXANDER D. JESS, TALLAHASSEE, FL (US); CHEUK TING HO, GAINESVILLE, FL (US); YANNIK K. WIGGEMANS, WEST PALM BEACH, FL (US); ALLAN M. AXELROD, GAINESVILLE, FL (US); MICHAEL E. WARKANDER, PANAMA CITY, FL (US); MICHAEL D. MAXEY, BEVERLY HILLS, FL (US)

(21) Appl. No.: 14/650,010

(22) PCT Filed: Dec. 5, 2013
(86) PCT No.: PCT/US2013/073391

§ 371 Date: Jun. 5, 2015

Related U.S. Application Data
(60) Provisional application No. 61/733,754, filed on Dec. 5, 2012.
(60) Provisional application No. 61/813,993, filed on Apr. 19, 2013.

(51) Int. Cl. G01M 3/32

(52) U.S. Cl. CPC G01M 3/3218; G01M 3/3209

(57) ABSTRACT

Embodiments relate to a method and apparatus for determining information relating to a leak in a package. In an embodiment, a solenoid/gravity system is used to rapidly pressurize a flexible package to a desired pressure and to rapidly withdraw the pressurizing agent, where another solenoid is used to rapidly and retractably impact a region on the package under test. Sensors are used to sense data corresponding to a wave in the package generated from the region of impact. The data is acquired and processed to determine information regarding a leak in the package, such as whether there is a leak in the package under test, the size of the leak, and/or the location of the leak.

### CROSS-REFERENCE TO RELATED APPLICATION

The present application claims the benefit of U.S. Provisional Application Ser. No. 61/733,754, filed Dec. 5, 2012, and U.S. Provisional Application Ser. No. 61/813,993, filed Apr. 19, 2013, both of which are hereby incorporated by reference herein in their entirety, including any figures, tables, or drawings.

### BACKGROUND OF INVENTION

Packages maintain the cleanliness and sterility of the product within from the manufacturing plant through transport, shelf life, and storage. Testing of the quality of seal and package integrity is of paramount importance in any packaging industry. As an example, the quality of the seal and integrity of a package dictates the shelf life of food products (e.g., chips, frozen foods, children's beverage/juice packages, meat, dairy products, and fresh vegetables), medical products (e.g., pharmaceuticals), and cosmetic products (e.g., skin care and makeup).

Although many package testing procedures exist, many of these tests involve destructive methods that are not adaptable to in-line testing. Therefore, test packaging or off-line samples are utilized for the testing, making it difficult to ensure the in-line packages are reliable and/or requiring a reduced yield in order to provide sufficient samples for off-line testing. In addition. the current non-destructive tests are time consuming, also resulting in reduced yield or fewer packages being tested on-line. Accordingly, there is a need in the art for fast, reliable integrity and quality of seal testing that can be performed in-line with packaging a product.

### BRIEF SUMMARY

Testing methods and equipment are provided for fast, non-destructive testing of the integrity and/or quality of seal for a variety of packages.

In an embodiment, a solenoid/gravity system is used to rapidly pressurize a flexible package to any desired pressure and to rapidly withdraw the pressurizing agent. Another) solenoid is used to rapidly and retractably impact a point on a package under test. Sensors are used to sense data corresponding to the behavior of the package after the package is impacted, such as data corresponding to a wave in the package generated from a point of impact. The data is acquired and processed to determine information regarding a leak in the package, such as whether there is a leak in the package under test, the size of the leak, and/or the location of the leak.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows simplified representation of a package testing configuration.

FIG. 2 shows an example scenario using four transducers disposed at equal distances from the vertical impact contact region.

FIG. 3 shows a package testing system according to an embodiment of the subject invention.

FIG. 4 shows a package testing system on a conveyer belt according to an embodiment of the subject invention.

FIGS. 5A and 5B show diagrams of a testing set-up for an embodiment of the subject package testing system.

FIG. 6 shows pressurization and control operation of an embodiment of the subject invention.

FIG. 7 shows an example of a user interface for an embodiment of the subject invention.

FIG. 8 shows an example data from an embodiment of the invention.

FIGS. 9A-9D show a comparison of signals received at 4 sensors for a package with a leak and a package without a leak, with respect to two specific embodiments of the subject invention (Embodiment 1—FIGS. 9A-9B, Embodiment 2—FIGS. 9C-9D).

FIG. 10 shows the results of the difference between an amplitude for a second impact node of a first impact and an amplitude of a first impact for 5 packages before and after introducing a leak with respect to the package.

### DETAILED DISCLOSURE

Embodiments of the subject invention relate to methods and apparatus for non-destructive testing of the integrity and/or quality of seal for a package. Embodiments can be applied to a variety of packages Implementations of embodiments of the invention can be used to test packages with flexible and/or compliant packaging, such as plastic packages, metal foil packages, PET, polypropylene, coated materials, polyolefins, paper, polyester, BOPET, BOPP, metalized BPP (biaxially-oriented polypropylene), PVDCpet, nylon, and aluminum foil (e.g., packages used to protect chips, frozen foods, medical supplies, cosmetics, etc.). According to certain embodiments, a method is provided utilizing dynamic impact characterization to determine whether a loss of pressure due to a leak in the package occurs.

Package testing includes ensuring the integrity of the sealed package, and assuring that no weaknesses in the sealed areas of the package permit leaks to develop with handling stresses and time. Package integrity testing can be referred to as a “leak test” of the package. That is, package integrity testing determines whether there is a failure in the materials or process that allows contamination to enter. Seal strength testing, on the other hand, measures an attribute of the seal, which is designed to ensure that the seal presents a barrier to at least the same extent as the rest of the package. Both integrity and seal testing are important aspects of ensuring proper packaging.

Package integrity testing is a measure of the package's barrier material and seal, providing a “leak test” of the whole package. In addition to seal bonding failures or disrupted seals, leakage can be the result of large holes, pinholes, or cracks in package materials. Either source of leakage represents the potential for product contamination from elements of the ambient atmosphere outside of the package entering the package, and the potential for the materials inside the package to escape.

Testing methods and equipment are provided for nondestructive testing of the quality of seal and/or integrity of a package. Embodiments can be designed for fast testing, such that the testing can be in-line with the packaging process.

Embodiments of the invention provide package testing capable of non-intrusive and less disruptive testing as compared to many existing test methods. According to certain embodiments, the nature of defects in a package seal can be identified. In specific embodiments, the general location of the defect can be identified.

In addition, methods and equipment described herein can be applied to any on-line production process for rapid evaluation of the quality of seal and/or package integrity. Implementations of embodiments of the subject apparatus can be provided in-line at a back-end of the product packaging process. In an embodiment, the package can be guided into, for example, a channel, where one or more forces can be applied to increase the internal pressure of the package. The pressurized package can then be impacted by a mechanism to apply a force to a region of the pressurized package over a short duration and then remove the force.

In specific embodiments, the impact can last less than 0.1, 0.2, 0.3, 0.4, 0.5, 0.6, 0.7, 0.8, 0.9, 0.10, 0.11, 0.12, 0.13, 0.14, 0.15, 0.16, 0.17, 0.18, 0.19, 0.2, 0.21, 0.22, 0.23, 0.24, and/or less than 0.25 seconds, and/or can last in a range between two for these time durations.

The existence and location of a leak can be quickly and easily determined by performing a non-destructive impact/blow on the package and comparing the force signatures generated by sensors in contact with the package and/or displacement detected by sensors in contact with or associated with the package.

According to one embodiment, an initial pressure is applied to a package under test. In one embodiment, the initial pressure can be applied by a restraining plate that holds the package in place. In various embodiments, the application of initial pressure can include, but is not limited to, negative pressurization, any “mechanical” form of pressurization, pressurization in a vertical direction, pressurization in a horizontal direction, pressurization by guiding the package between two rails/belts, pressurization by gravity, use of materials other than a rigid plate for pressurization, pressurization by clamps in corner(s) and/or edges of package, using transducers to both sense and apply pressure, use of a linear actuator or other motor to drive pressurization plates, use of pneumatic system, or a combination thereof

In a specific embodiment, the force that applies the initial pressure is applied by pushing on the external surface of the package with one or more force sensors, or displacement sensors, where the force sensors monitor the force applied to the package, and detect the behavior of the package material after impact. The sensor can also monitor the package upon applying the force(s) to pressurize the package and determine when the package has reached an equilibrium after the application of the pressurization force(s) to then trigger impact, and then produce data regarding the force, or displacement, experienced by the sensor(s) after impact. In a specific embodiment, a time delay, e.g. of at least 100 msec, 200 msec, 300 msec, 400 msec, 500 msec, or in a range between two of these time durations can be allowed after initial pressurization before triggering the impact, to allow the package to reach equilibrium. The structures holding the sensors in contact with the package can be low vibration structures and hold their position accurately during and after the impact.

After initial pressure is applied, a region of the package is impacted with a force sufficient to create a disturbance to the package while not destroying the package. The impact can be performed, for example, by using an impacting rod. In some embodiments, the impact can be accomplished by ultrasound excitation of content, an impact by air gun, gravity weight, projectile, pendulum, electromagnetic (EM) wave, steady jet, worm gear, linear actuator, combination of gravity and a pendulum, hydraulic, or a combination thereof. Of course, embodiments are not limited thereto.

Solenoids can be used to control pressure and the impact, such as force of impact, depth of impact, and/or duration of impact.

In one embodiment, force sensors/transducers in contact with the package and spaced a distance away from the impact region of the package detect a force signature from the impact. The existence of a leak is determined by evaluating the force signature. In other embodiments, displacement can be measured using a vision system, a strain gauge, a capacitive detector, a laser system, radar, sonar, and the like. The displacement of the package at one or more points or regions of the package can be measured. In some embodiments, an analog response can be used instead of a transducer.

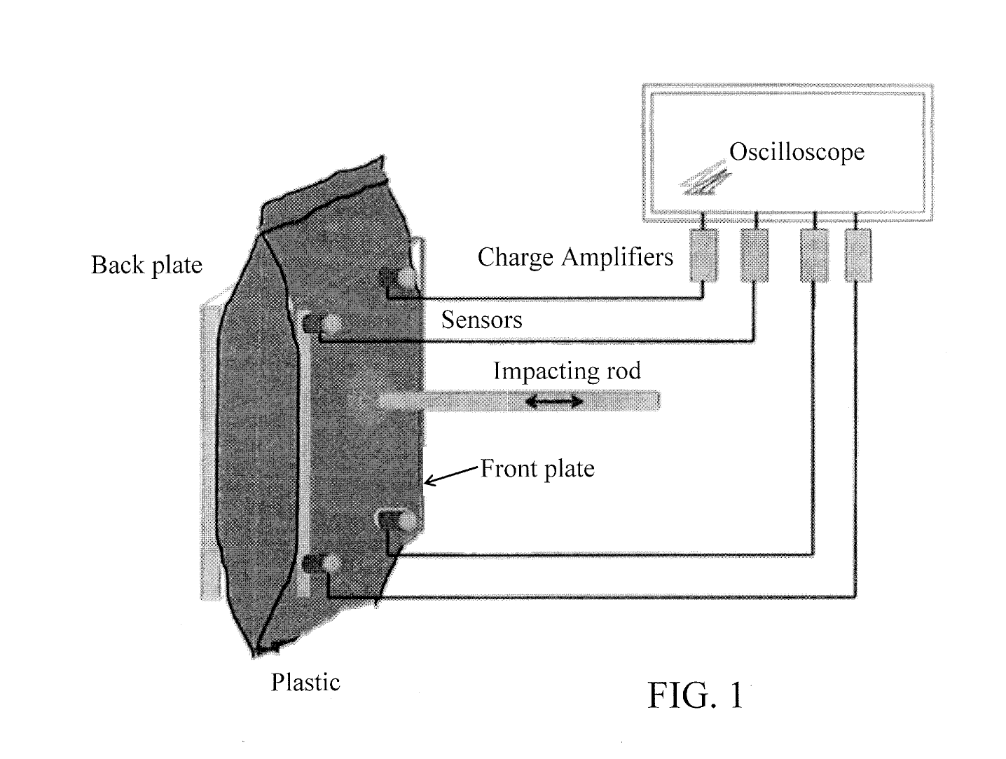

FIG. 1 shows simplified representation of a package testing configuration. As shown in FIG. 1, a package is pressurized and impacted. A front plate can apply an initial pressure by exerting pressure onto the package against a back plate (or other surface). An impacting rod can be used to generate a wave from the point of impact. Sensors are used to detect the package integrity. Four transducers are shown. Charge amplifiers may be used with the sensors to amplify the signals.

When a seal or package is intact and of good quality, the four transducers provide similar force signatures, i.e., the four signals have the same amplitude, duration and shape. However, when there is leak, either the sensor(s) closest to the location of the leak may show a different reading or all the four signals generated by the transducers will be of slightly lower amplitude and longer duration. Specific embodiments can apply a pressure and then hold the position of the pressure applying equipment in a constant relative position to the package, such that the pressure may drop if there is a leak. Other embodiments can apply a pressure and then maintain the pressure during the testing.

A specific embodiment can place a carriage on top of the package, such that a constant weight is applied to the package, and if the contact area between the carriage and package are maintained a constant pressure is applied to the package. Which one of these two scenarios will occur depends on the size of the package, size of the leak, distance of the leak location from the transducer, pressure inside the package, duration and amplitude of the impact, external pressure applied by the plate on the package, method of holding, etc. In a specific embodiment, the sensors are positioned to be equidistant from the region of impact such that the force or displacement signatures are similar when no leak is present. Other embodiments can position the sensor at different distances or positions with respect to a package structure in order to achieve a desired data gathering characteristic. An embodiment can use 1, 2, 3, 4, or more such sensors.

The sensors can detect a wave generated from point of impact. A weaker signal can imply a leak near that sensor due to the reduced pressure in that area.

A specific embodiment can protrude the sensor from a plate or other structure such that the sensors are the only structure in contact with the package (i.e., the plate is not in contact with the package) and the sensors apply the force in the vicinity of the impact. Of course another structure on the other side of the package may provide one or more forces to the other side of the package as the sensors push on the package. In a specific embodiment, there is no other structure in contact with the package between the region of impact and the sensors applying the force(s) for pressurization. A plate can be used to push the sensors while the sensors push the package.

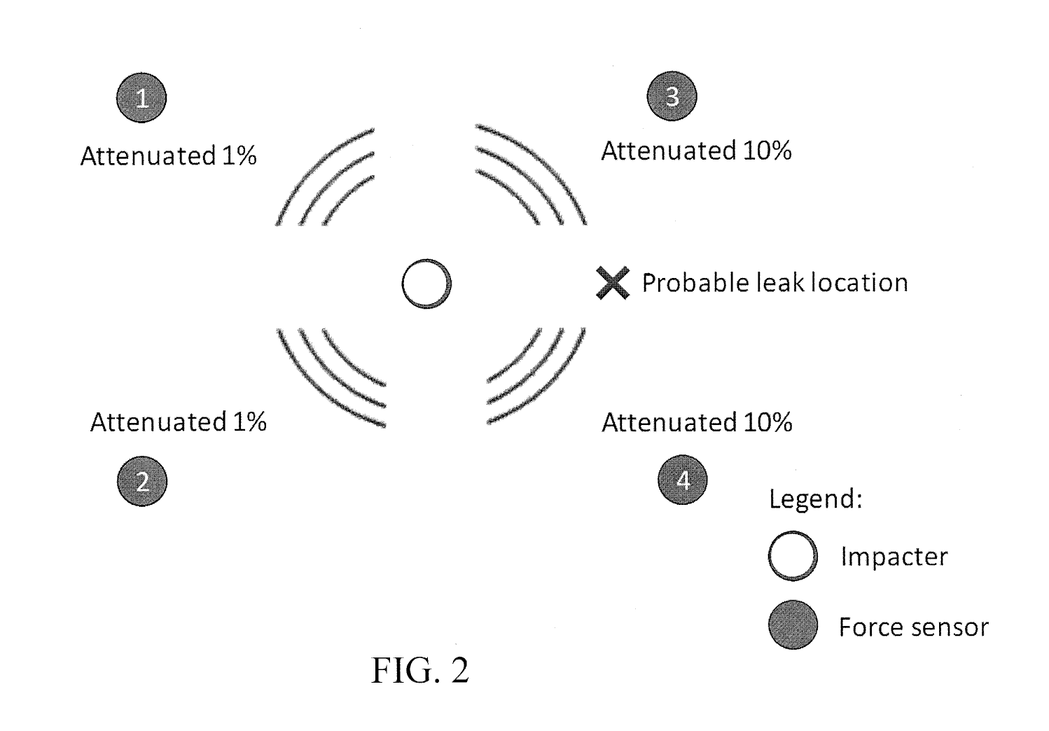

FIG. 2 shows an example scenario using four transducers disposed at equal distances from the vertical impact contact region. A leak can be indicated by the at least one transducer (closest to the leak) showing a different force signal; for example, a force signal with a greater attenuation as compared to other signals. The force signatures of the various sensors can have differences in other respects, such as magnitude of one or more peaks or troughs, spacing between peaks or troughs, relative magnitudes of adjacent or other space magnitudes or troughs. As shown in FIG. 2, if a first sensor (1) shows a 1% attenuation, a second sensor (2) shows a 1% attenuation, a third sensor (3) shows a 10% attenuation, and a fourth sensor (4) shows a 10% attenuation from an impact, the probable leak location is between the third and fourth sensor.

Certain embodiments are directed to one or more of: performing leak detection in under 0.3, 0.4, 0.5, 0.6, 0.7, 0.8, and/or 0.9 seconds, or in a range between any two of these listed time durations, being sensitive to leaks greater than 25, 50, 75, 100, 125, 150, 175, and/or 200 micrometers, having a false positive rate under 0.0004%, 0.0005%, 0.0006%, 0.0007%, 0.0008%, 0.0009%, and/or 0.001%, being automated, having a sanitary design, and a relatively long lifespan (e.g., 15+ years).

A greater understanding of the present invention and of its many advantages may be had from the following examples, given by way of illustration. The following examples are illustrative of some of the methods, applications, embodiments and variants of the present invention. They are, of course, not to be considered in any way limitative of the invention. Numerous changes and modifications can be made with respect to the invention.

According to an embodiment, a solenoid/gravity system is used to rapidly pressurize a flexible package to any desired pressure and to rapidly withdraw the pressurizing agent. Alternatively, the forces creating the pressurization can be independent of gravity and be applied by a solenoid or other mechanism to apply force, such as a spring or other passive device, or other known device. Another solenoid can be used to rapidly and retractably impact a point on a package under test. Alternative embodiments can use other physical mechanisms to apply the impact such as a spring loaded arm, a projectile, or other device.

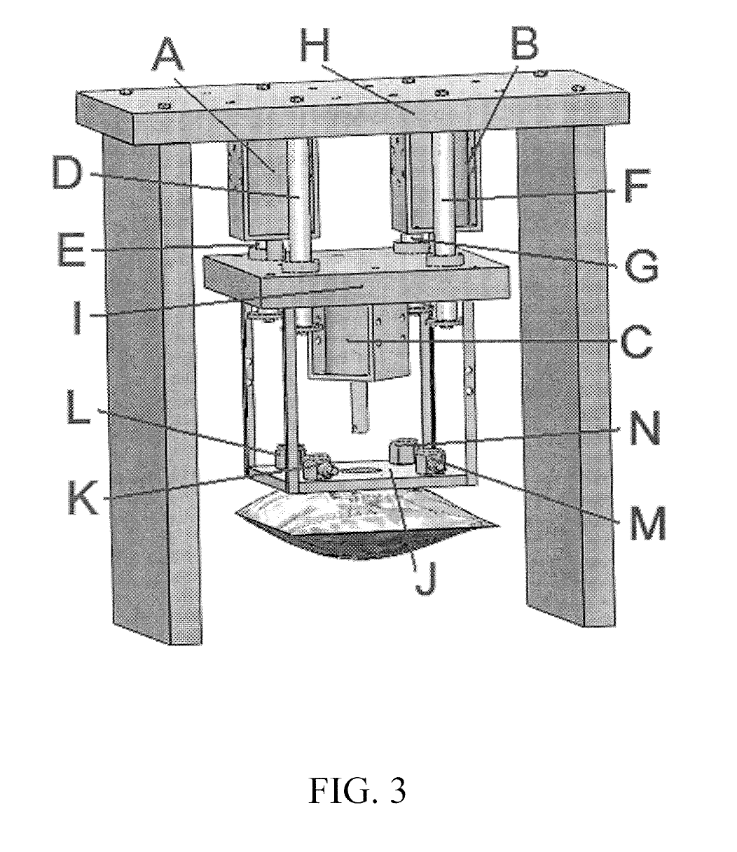

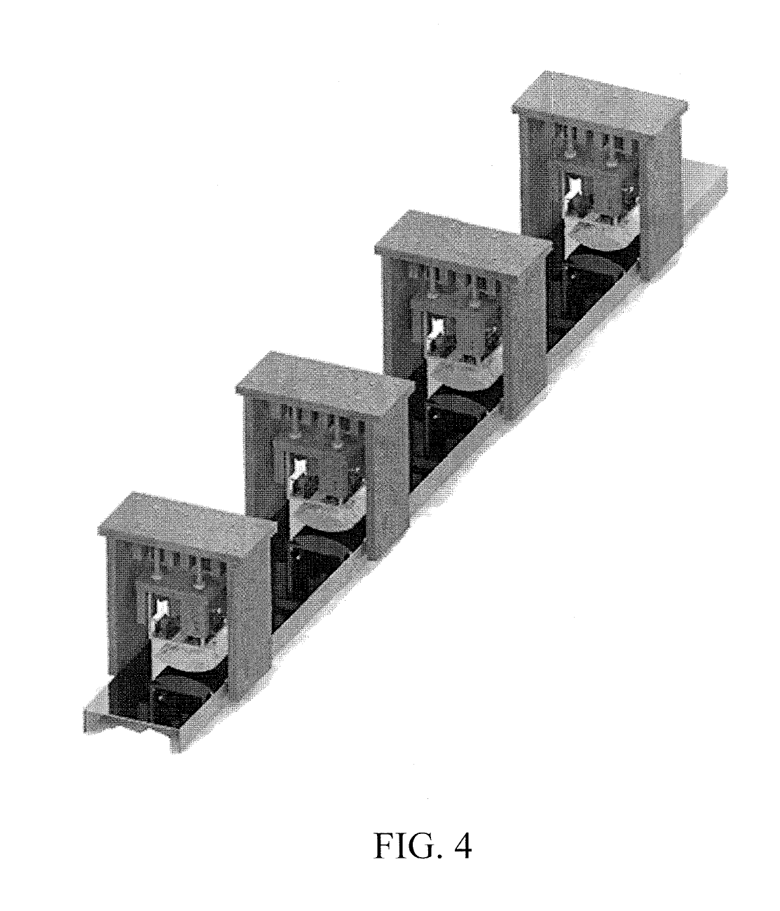

FIG. 3 shows a package testing system according to an embodiment of the subject invention. The embodiment can be used to test packages moving along a conveyer belt such as shown in the configuration of FIG. 4.

Returning to the embodiment shown in FIG. 3, external pressure and impacts are controlled using solenoids. For example, two solenoids A and B can be used to exert (e.g., control) an initial pressure on a package (Digikey 527-1021-ND; 12 527-1021-ND; 1.25″ are used in the embodiment shown) and solenoid C can be used to exert an impact on the package (Digikey 527-1016-ND; 12 V; 1″ is used in the embodiment shown). Guiding rods D, E, F, and G, can be configured at sides/corners of a middle plate I to facilitate substantially equal vertical application of the pressure. Two guiding rods D and E can be controlled by solenoid A and two guiding rods F and G can be controlled by solenoid B. A bottom plate J can suspend from and be guided by the middle plate I. The bottom plate J can perform the function of the front plate as described with respect to FIG. 1. Four sensors K, L, M, and N can be disposed on the bottom plate J. In one embodiment, the sensors are piezoelectric force sensors (PCB 208C01 piezoelectric are used in the embodiment shown). Other types of sensors can be used, such as laser, or other light, reflecting systems, radio-frequency electromagnetic radiation reflection technology, and other types of sensors known in the art. The sensor can be less than or equal to ½ inch in diameter, less than or equal to ¼ inch in diameter, or other sizes. Specific embodiments can have the sensors spaced about by less than a certain distance such as less than or equal to 1.0, 0.9, 0.8, 0.7, 0.6, 0.5 inches, or other decimal spacing to ensure a sensor is near the leak.

A top plate H can support the impacting system. By suspending the impacting system from the top plate H, gravity can be used to impart pressure and assist in the impact. Specific embodiments can lock the plate in place to avoid or reduce movement of the plate due to the impact. Accordingly, embodiments, including the embodiment shown in FIG. 3, can use a solenoid/gravity system to rapidly pressurize a flexible package to any desired pressure and to rapidly withdraw the pressurizing agent. Specific embodiments can rely on gravity to apply the pressure, where if the structure incorporating plate J and plate I is allowed to “rest” on the package and the area of contact between the package and plate J is constant, then a constant pressure is applied. Other embodiments can program the solenoids to apply a constant force, such that if the area of contact between the package and plate J is constant, a constant pressure is applied. Maintaining a constant surface area applying the force(s) can be made easier by applying the force(s) with the surface area of the sensor(s). Other embodiments can create an initial pressure and then hold the position of plate J in a fixed position such that if the fluid (e.g., gas and/or liquid) inside the package leaks out the pressure may drop with time during the measurement.

The impacting mechanism for the embodiment shown in FIG. 3 is a 12V, 1 Amp solenoid. The impact takes approximately 0.15 seconds. The pressurizing is carried out by two 12V, 4 Amp lifting solenoids. The dropping and pressurizing takes about 0.25 seconds. Lifting after leak test takes approximately 0.1 seconds. Each solenoid lifts 44 oz. The assembly only weighs 36 oz.

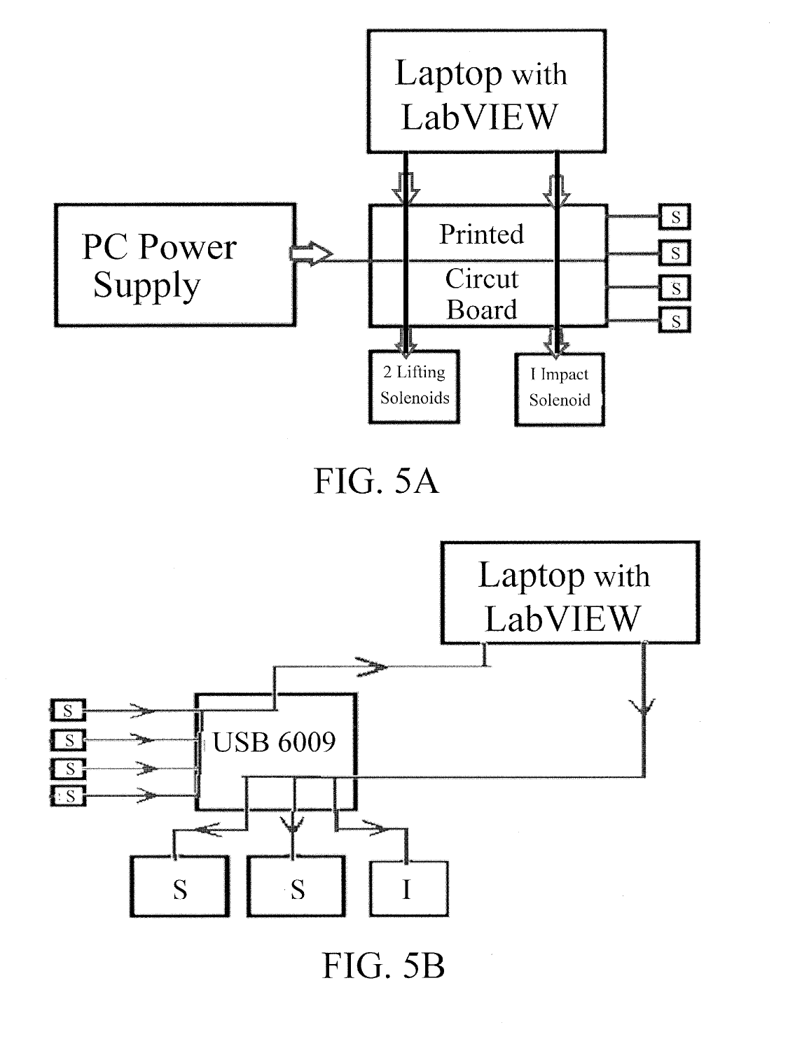

FIGS. 5A and 5B illustrate signal gathering and processing for the embodiment shown in FIG. 3. According to the experimental set-up, a laptop running a signal processing software, such as LabVIEW, a trademark of National Instruments Corp., can be connected to a printed circuit board (PCB), such as USB 6009, which enables the control and supply of power to the two lifting solenoids (A, B) and the one impact solenoid (C), as well as the four sensors. In this embodiment, a subsystem controls the solenoids to lift/lower apparatus and to impact the package, enabling pressurization and impact. A subsystem provides data acquisition by reading sensor outputs with analog-to-digital conversion (ADC) and performing a conversion to force. Specific embodiments can collect data from dynamic sensors. A subsystem provides signal processing by calculating the presence and location of leaks. Specific embodiments can process the signals to determine the presence, location, type, and/or size of the leak.

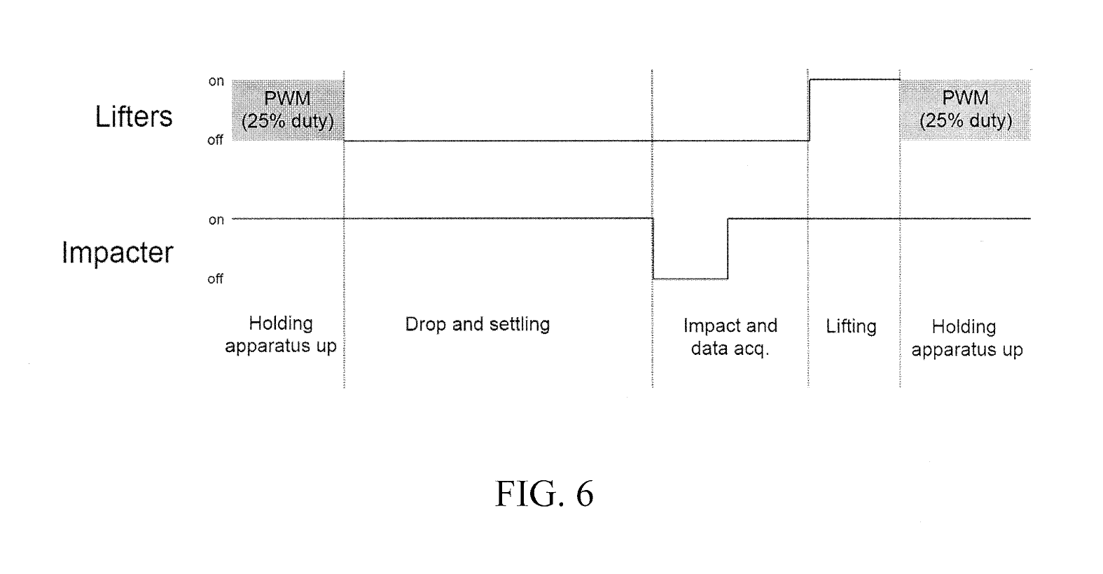

FIG. 6 shows pressurization and control operation of the embodiment shown in FIG. 3. Lifters can be operated at reduced power when holding the apparatus up to avoid overheating. After the apparatus drops, it is allowed to settle, then the impacter fires.

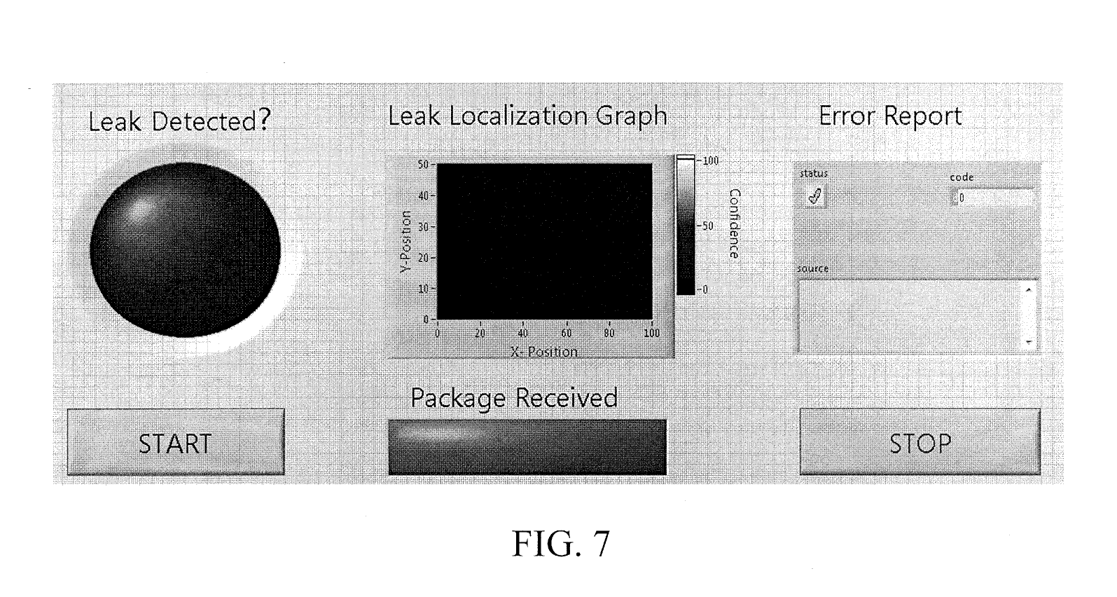

FIG. 7 shows an example user interface.

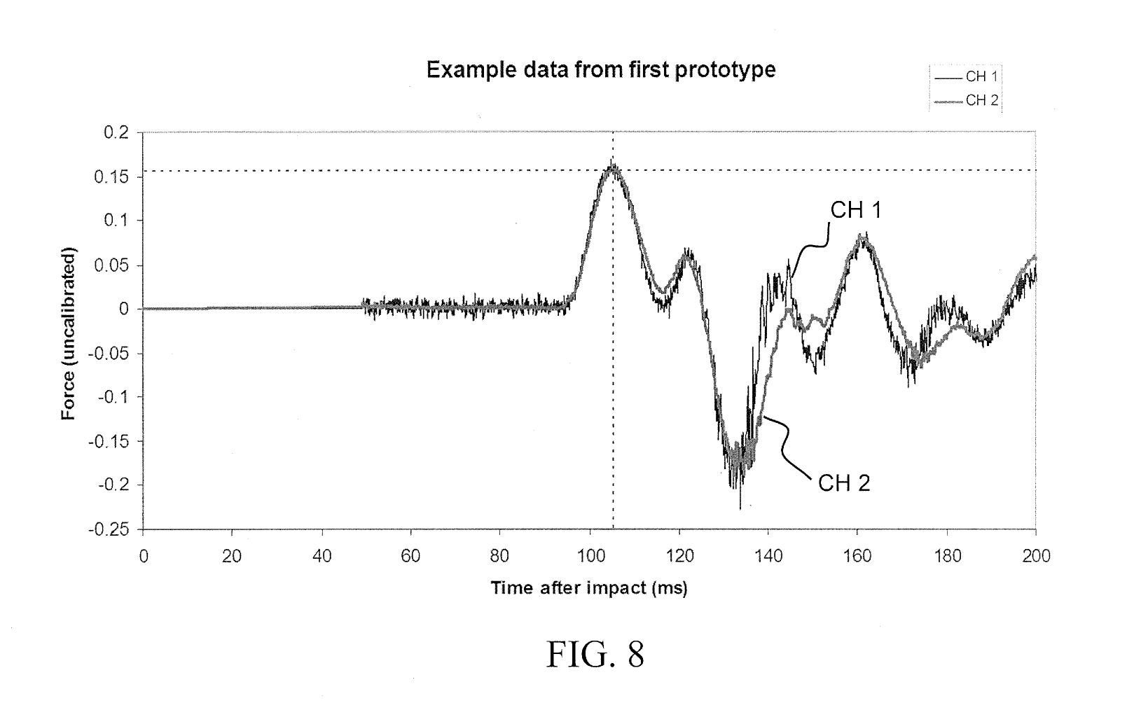

FIG. 8 shows an example data from the embodiment shown in FIG. 3. To detect a leak, a first peak on each channel can be determined. For example, the data from the sensors can be normalized (e.g., the data is divided by values obtained from a non-leaky package). An example result from the data shown in FIG. 8 resulted in a first-peak magnitude on channel 2 being 15% less than expected. After normalizing the data, the normalized data is compared to thresholds. For the example result, if any first peak is attenuated more than 5%, 6%, 7%, 8%, 9%, 10%, 11%, 12%, 13%, 14%, and/or 15% (this embodiment's threshold is 10%), then the result indicates a leak. With a 15% attenuation, then it can be determined that a leak was detected.

Other analysis techniques can be used to determine whether a leak exists, how big the leak is, and/or where the leak is. A leak in a package can result in an increased force or displacement signal amplitude when performing leak testing. In specific embodiments, a distinct trough in the signal can occur immediately following the initial peak, indicating a leak. Benchmarks of peaks and troughs for signals of non-leak bags can be benchmarked, and then, when a package or bag is tested, statistical analysis is performed to determine whether the signal has significantly different peaks and troughs than the benchmark, in order to determine whether there is a leak. In an embodiment, this analysis is performed for all four sensors, so the leak determination can be made if 1-2 (or any number) of sensors agree that the signal is significantly different from the benchmark.

In addition, or instead of, the first peak or trough of the signal, additional peaks and troughs can be used in characterization. The period of oscillation of the signal can also be utilized in leak determination. Changes in this characteristic can be effective in detecting leaks.

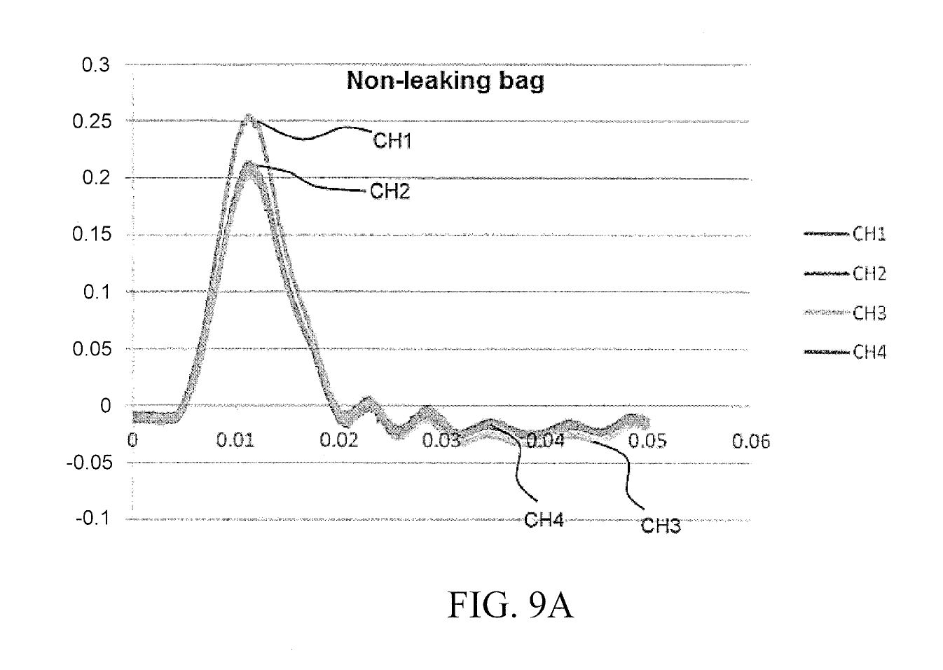

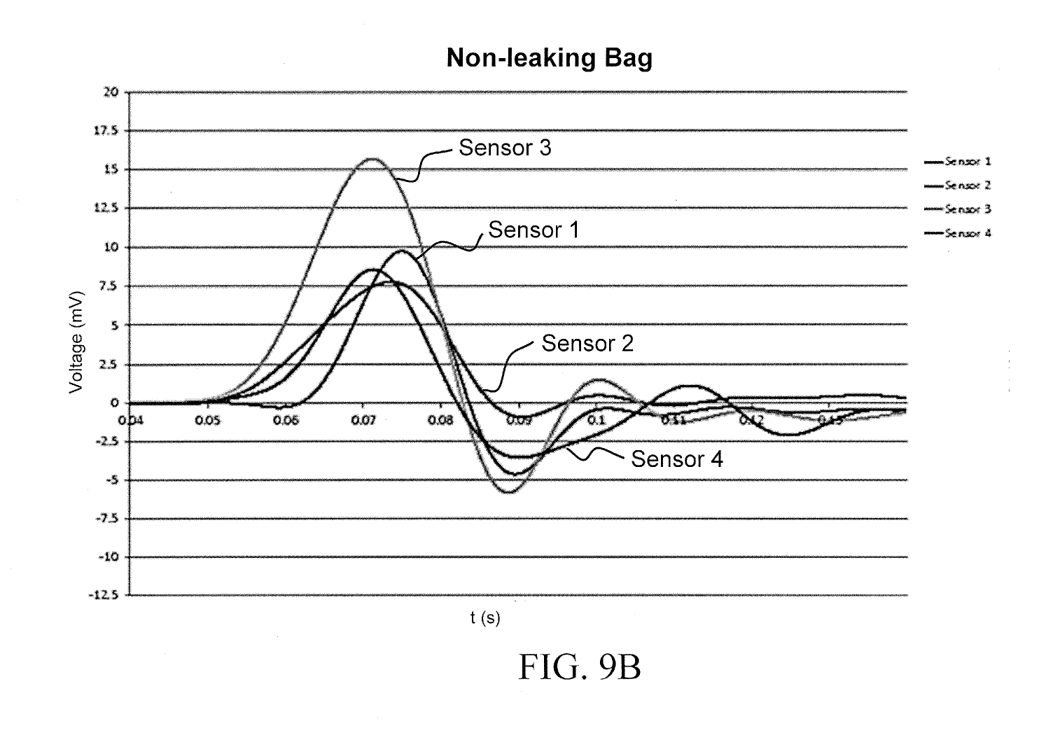

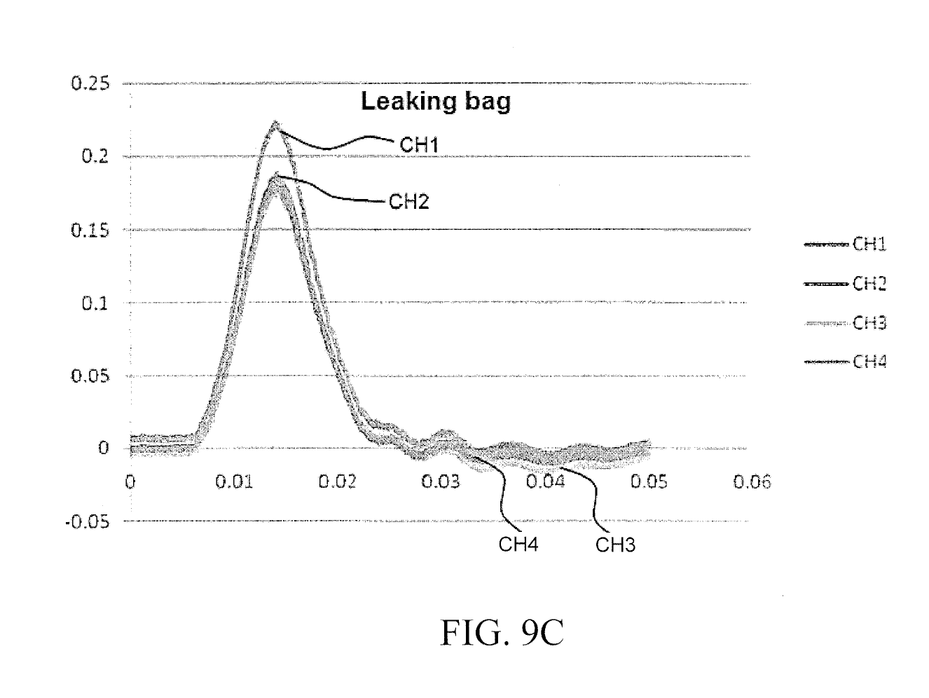

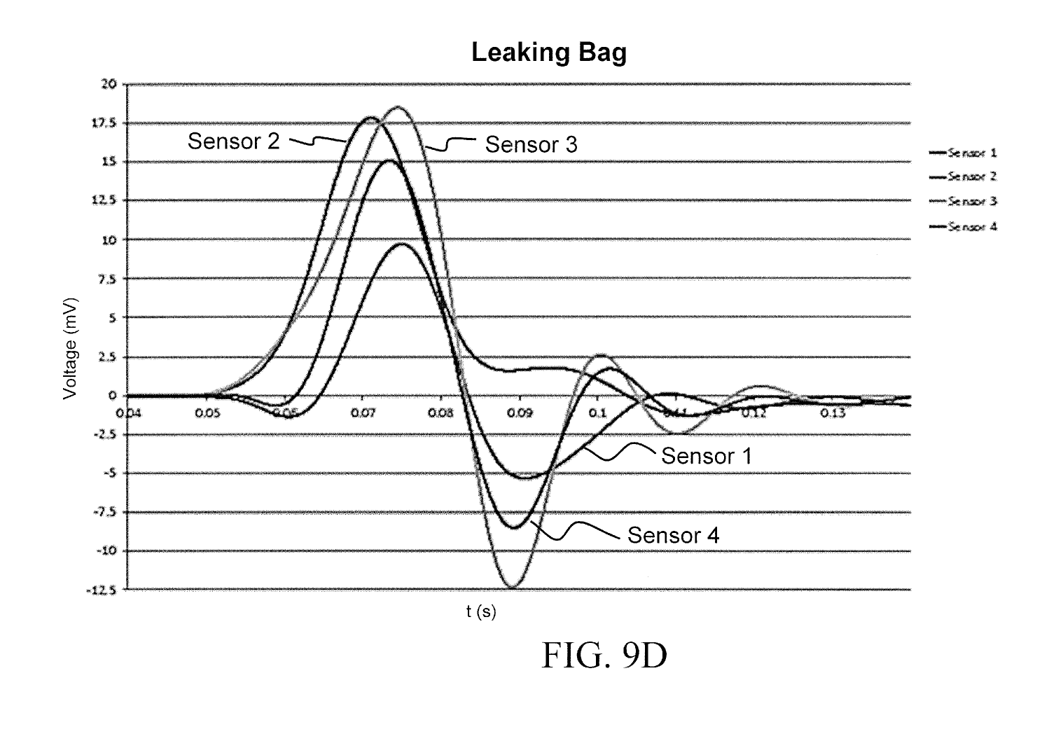

FIGS. 9C and 9D show an increase in the magnitude when a leak is present compared to when a leak is not present. The trough in the graphs of FIGS. 9C-9D should be noted as well. These graphs are based on data that has been filtered to remove electrical noise. The leak signature for a package with a leak can also have a different trough location, trough size, and/or trough length.

Specific embodiments of the detection protocol can utilize one or more of the following:

the magnitude of the initial peak, where certain bag types may cause the initial peak to be inverted, certain packages may have a higher magnitude with a leak and others a lower magnitude;

the magnitude of 2nd, 3rd, or other later peaks, where these later peaks may or may not be evident on the graphs shown in FIGS. 9C-9D (note, if a fluid-filled bag is being tested, the later peaks are more evident and these peaks may become more prevalent in gas filled bags if testing conditions are adjusted);

the magnitude of the initial trough;

the magnitude of later troughs;

the comparison (e.g., ratio, spacing) of initial or later peaks to each other (for an example—this characteristic can be determined using the logarithmic decrement (http://en.wikipedia.org/wiki/Logarithmic_decrement));

the comparison of initial or later troughs to each other using logarithmic decrement;

the period of oscillation determined by identifying a time difference between any peak or trough, such as finding the time difference between the first and second peak, or using other peaks or troughs (for example, if the time difference is found between the 3rd peak and 3rd trough, then that time difference can be multiplied by 2 to find the actual period. However, if the time difference is found between the 1st peak and 3rd peak, that time difference can be divided by 2 to find the actual period);

the frequency of oscillation of the signal, which can be related to the period of the signal;

the calculated natural frequency of the package or material in the package, or the material/package combination, based on the signal;

the calculated resonant frequency of the material based on the signal;

this material could encompass the material of the package and/or the contents of the package;

the amount of time between the impact and the initial peak or trough (this can determine how long it actually takes for the wave to travel from the impact to the sensor. Similarly, this time period can be characterized by the amount of time between the impact and a later peak or trough);

characterizing the signal by referencing a peak to the time the impacting rod is released rather than the timing of the impact itself. Any other significant reference point in the testing process can be used to determine the location of a specific peak or trough;

the damping ratio of the signal (http://en.wikipedia.org/wiki/Damping_ratio);

the total energy transmitted by the impact to the sensor via the propagating wave; and

the area under the curve from the beginning of the wave to the time where the wave is dissipated can be used to determine the energy of the impact. Similarly, the area can be taken during a specified time frame (for example, from the start of the wave until 5 milliseconds later). The signal could also be normalized before finding the area by subtracting the DC offset.

Specific embodiments can utilize multiple impacts of the package while the package is under a constant pressurization or a changing pressurization. A specific embodiment makes two separate impacts and take measurements from the wave that propagates for each impact. From that, the leak determination is made by comparing the second impact to the first impact for either each individual sensor or an average of all four (or other number) sensors. In an embodiment, if the second impact produces a lower magnitude initial peak and trough, then it is determined that a leak exists. However, if the second impact produces the same magnitude leak/trough as the first impact, then the bag does not have a leak. Statistical analysis has been performed on this data to determine whether there is a leak.

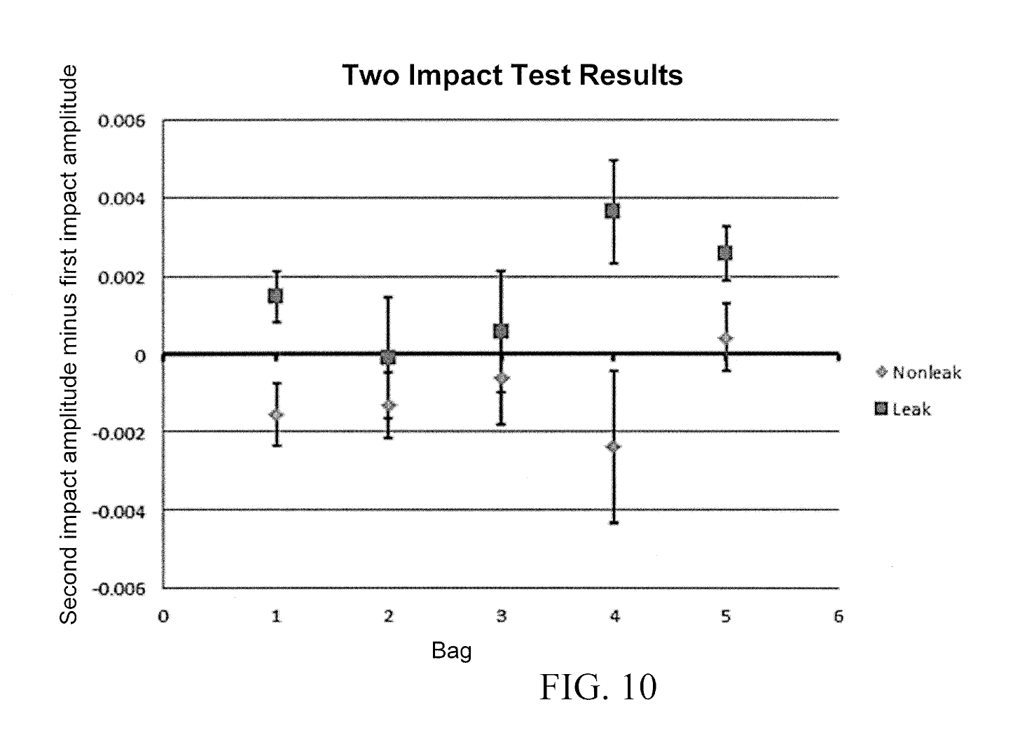

The graph in FIG. 10 shows data for 5 separate bags and how the difference in first peak amplitude between first and second impact varies based on a leak and non-leak bag. The first impact can cause the signal from the second impact to have a different magnitude, and/or the package leaking from being pressurized, can cause the second impact to have a different signal. Specific embodiments can use 3 or more impacts. How far apart the impacts are, the magnitude of the impacts, and other variables can be varied and taken into account in the determination of a leak. The change in magnitude of the second impact peak can be due to a combination of the first impact and the continued pressurization. In an embodiment, the subsequent impact can occur after the signal from the previous impact dissipates. The subsequent impact can occur before that time, and any residual effects from the previous impact can be adjusted for. The impacts can be the same or different magnitude.

Referring to FIG. 10, determining the presence of a leak with a specific method, a point on the graph in FIGS. 9C-9D was found by finding the difference in first peak amplitudes for the first and second impact for each sensor. The average difference among all 4 sensors was found, and this average value represents one point on the graph. The standard deviation of differences among the four sensors was also found for each data point. The error bars in FIG. 10 represent one standard deviation above and below the average difference. A leak was determined when the lower error bar was above the horizontal axis (as shown in 3 out of the 5 leak data points in the graph above). This signifies that the second impact did indeed produce a larger amplitude than the first.

Other specific methods utilizing multiple impacts can include one or more of the following:

use individual sensors rather than an average of multiple sensors, allowing a leak determination to be made if, for example, 3 out of 4 sensors had a larger peak amplitude on the second impact;

using more than 2 impacts, where, optionally, comparisons among subsequent impacts can provide additional data for determining leak existence;

the leak determination can be made through some other statistical analyses known in the art, (such as a hypothesis test or t-test); and

other signal characteristics are compared between first and second (or subsequent) impacts, such as the characteristics discussed above for embodiments using a single impact.

A weighted average can be used with other characteristics. As an example, a larger first peak amplitude can be worth 2 points toward a leak determination, whereas a larger trough can be just 1 point. Then the leak determination is made when a certain point value is reached.

### Embodiments

A specific embodiment relates to a method of leak detection of a package comprising:

pressurizing a package by applying an initial pressure through a plate controlled by a solenoid;

impacting a region of the package under control of an impact solenoid;

acquiring data relating to the impacting of the region from at least one sensor;

determining an existence of a leak by normalizing data related to a first peak magnitude from the at least one sensor and comparing the normalized data to a threshold.

A specific embodiment relates to a system for leak detection of a package, comprising:

a lifter for holding a pressurizing and impacting system above a package;

a solenoid controlling a release of the lifter to apply an initial pressure onto the package;

a solenoid controlling an impacter for impacting a region of the package; and

at least one sensor for acquiring data relating to the impacting of the region.

A specific embodiment relates to a system for leak detection of a package, comprising:

a pressurization and impact module controlling solenoids to lift/lower a pressurizing and impacting apparatus;

a data acquisition module to read sensor outputs and perform conversions including analog to digital conversion and/or conversion to an indication of force; and

a signal processing module to calculate presence and location of leaks.

This embodiment can optionally configure the signal processing module to normalize data corresponding to a first peak of a signal received by the data acquisition module and compare the normalized data to a threshold.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

Aspects of the invention, such as controlling pressurization and impacting the package, signal acquisition from the sensors, and processing the data collected to analyze the package quality and/or integrity, may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.

Computer-readable media include both volatile and nonvolatile media, transient and non-transient media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A method of leak detection of a package comprising:
pressurizing a package by applying an initial pressure to the package;
impacting a region of the package;
acquiring data relating to the package behavior after impacting the region of the package;
determining information relating to a leak in the package from the data relating to the package behavior after impacting the region of the package.

2. The method according to claim 1, wherein the initial pressure is applied by applying one or more forces to an external surface of the package.

3. The method according to claim 1, wherein acquiring data relating to the package behavior after impacting the region of the package is accomplished via one or more sensors.

4. The method according to claim 1, wherein determining information relating to a leak in the package comprises normalizing data related to a first peak magnitude from the at least one sensor and comparing the normalized data to a threshold.

5. The method according to claim 2, wherein acquiring data relating to the package behavior after impacting the region of the package is accomplished via one or more sensors, wherein applying the one or more forces to the external surface of the package comprises applying the one or more forces via the one or more sensors.

6. The method according to claim 1, wherein the package is held in place during and after impacting the region of the package until at least a portion of the data is acquired.

7. The method according to claim 6, wherein a structure used to hold the package in placed is fixed in place during and after impacting the region of the package until at least a portion of the data is acquired.

8. The method according to claim 1, wherein there is a delay of at least 100 msec between pressurizing the package and impacting the region of the package.

9. The method according to claim 1, wherein the package comprises a flexible and/or compliant portion.

10. The method according to claim 9, wherein the region of the package impacted is within the flexible and/or compliant portion.

11. The method according to claim 10, wherein acquiring data relating to the package behavior after impacting the region of the package comprises acquiring data relating to the behavior of the flexible and/or compliant portion.

12. The method according to claim 1, wherein the data acquired is a force a portion of an external surface of the package applies to a sensor in contact with the portion of the external surface.

13. The method according to claim 1, wherein the data acquired is a displacement a portion of an external surface of the package experiences.

14. The method according to claim 1, further comprising:
repeating impacting the region of the package,
acquiring data relating to the package behavior after impacting the region of the package, and
determining information relating to a leak in the package from the data relating to the package behavior after impacting the region of the package,
wherein determining information comprises comparing the data acquired from impacting the region of the package the first time and the data acquired from impacting the region of the packing a second time.

15. The method according to claim 1, wherein pressurizing, impacting, and acquiring is accomplished in less than 0.5 seconds.

16. The method according to claim 3, wherein the one or more sensors is two or more sensors.

17. The method according to claim 1, wherein the initial pressure is maintained during impacting and acquiring.

18. A system for leak detection of a package, comprising:
a pressurizer, wherein the pressurizer applies an initial pressure to the package;
an impacter, wherein the impacter impacts a region of the package; and
at least one sensor for acquiring data relating to the package behavior after the impacter impacts the region of the package.

19. The system according to claim 18, further comprising:
a processer, wherein the processer processes the data relating to the package behavior after the impacter impacts the region of the package to determine information relating to a leak in the package.

20. The system of claim 18, wherein the signal processing module is configured to normalize data corresponding to a first peak of a signal received by the data acquisition module and compare the normalized data to a threshold.
